(19) United States
(12) Patent Application Publication
(10) Pub. No.: US 2016/0049884 A1
(43) Pub. Date: Feb. 18, 2016

(54) POWER CONVERSION DEVICE

(71) Applicant: TOSHIBA MITSUBISHI-ELECTRIC INDUSTRIAL SYSTEMS CORPORATION, Chuo-ku,Tokyo (JP)

(72) Inventor: Shinzo TAMAI, Chuo-ku (JP)

(73) Assignee: TOSHIBA MITSUBISHI-ELECTRIC INDUSTRIAL SYSTEMS CORPORATION, Chuo-ku, Tokyo (JP)

(21) Appl. No.: 14/782,170

(22) PCT Filed: Apr. 5, 2013
(86) PCT No.: PCT/JP2013/060468

§ 371 Date: Oct. 2, 2015

(51) Int. Cl. H02M 7/44

(52) U.S. Cl. CPC H02M 7/44

(57) ABSTRACT

A power conversion device: including a group of serial three-level inverters in which 2ⁿ three-level inverters connected in series; and at least one switch circuit that selects an output from either one of two three-level inverters in the group of serial three-level inverters. Furthermore, 2ⁿ⁻¹ switch circuits are connected such that an output from either one of two adjacent three-level inverters in the group of serial three-level inverters can be selected. In the case where two or more switch circuits are connected, one output is obtained by sequentially connecting the switch circuits in a following stage such that an output from either one of two switch circuits connected in a previous stage can be selected.

### TECHNICAL FIELD

The present invention relates to a power conversion device, and particularly to a power conversion device that can output a plurality of different levels of voltages.

### BACKGROUND ART

There has been proposed a power conversion device that changes the accumulation of direct-current (DC) voltages from a plurality of DC power supplies in one cycle to convert the DC power into alternating-current (AC) power. This power conversion device does not generate a fixed pulse-like voltage as in the case of an inverter including one DC power supply, but accumulates a plurality of DC voltages having different electric potentials and converts DC power into AC power. Accordingly, by meticulously accumulating a plurality of DC voltages having different electric potentials without waste, this power conversion device can convert DC power into AC power with few harmonics, as compared with a power conversion device having one DC power supply.

Specifically, Japanese Patent Laying-Open No. 2000-341964 (PTD 1) discloses a multilevel inverter that corresponds to the above-mentioned power conversion device.

The multilevel inverter disclosed in PTD 1 includes a redox flow-type secondary battery connected in series to produce multilevel terminal voltages, and an inverter unit that controls the accumulated electric potentials at the multilevel terminal to produce AC power. The inverter unit includes a total of eight switching elements and six diodes, and is configured to control the opening/closing of the switching elements in accordance with an instruction from a control unit.

### CITATION LIST

### Patent Document

PTD 1: Japanese Patent Laying-Open No. 2000-341964

### SUMMARY OF INVENTION

### Technical Problem

FIG. 5 is a circuit diagram showing the circuit configuration of a conventional power conversion device disclosed in PTD 1. A power conversion device 100 shown in FIG. 5 is a five-level inverter that can output five different levels of voltages. Power conversion device 100 includes four DC power supplies V, eight switch elements S101 to S108, and six diodes D101 to D106.

In power conversion device 100, the intermediate point of four DC power supplies V is defined as a midpoint V0, and the voltage level at midpoint V0 is defined as “0V”. Accordingly, in power conversion device 100, the voltage level on the positive potential side by one DC power supply V relative to midpoint V0 is set as “+1V” while the voltage level on the positive potential side by two DC power supplies V relative to midpoint V0 is set as “+2V”. On the other hand, in power conversion device 100, the voltage level on the negative potential side by one DC power supply V relative to midpoint V0 is set as “−1V” while the voltage level on the negative potential side by two DC power supplies V relative to midpoint V0 is set as “−2V”.

Power conversion device 100 can output an electric potential having a voltage level of “+2V” from the output terminal by turning switch elements S101, S102, S 103, and S104 ON. Also, power conversion device 100 can output an electric potential having a voltage level of “+1V” from the output terminal by turning switch elements S102, S103, S104, and S105 ON. Furthermore, power conversion device 100 can output an electric potential having a voltage level of “0V” from the output terminal by turning switch elements S103, S104, S105, and S106 ON. Also, power conversion device 100 can output an electric potential having a voltage level of “−1V” from the output terminal by turning switch elements S104, S195, S106, and S107 ON. Power conversion device 100 can output an electric potential having a voltage level of “−2V” from the output terminal by turning switch elements S105, S 106, S 107, and S108 ON. Therefore, power conversion device 100 can output five different levels of voltages (“−2V”, “-−V”, “0V”, “+1V”, and “+2V”) from the output terminal.

According to power conversion device 100, however, when switch elements S105, S106, S107, and S108 are turned ON in order to output an electric potential having a voltage level of “−2V” from the output terminal, the voltage level at the anode terminal in each of diodes D102, D104, and D106 reaches “−2V”. In this case, since diode D102 is connected at its cathode terminal to the voltage level of “+1V”, voltages of three DC power supplies V are to be applied to this diode D102. Similarly, voltages of two DC power supplies V are to be applied to diode D104 and a voltage of one DC power supply V is to be applied to diode D106.

Furthermore, according to power conversion device 100, when switch elements S101, S102, S103, and S104 are brought into an ON state in order to output an electric potential having a voltage level of “+2V” from the output terminal, the voltage level at the anode terminal in each of diodes D101, D103, and D105 reaches “+2V”. In this case, since diode D105 is connected at its cathode terminal to the voltage level of “−1V”, a voltage corresponding to the sum of voltages of three DC power supplies V is applied to diode D105. Similarly, a voltage corresponding to the sum of voltages of two DC power supplies V is applied to diode D103 and a voltage of one DC power supply V is applied to diode D101.

In this way, in the multilevel inverter disclosed in PTD 1, diodes D102 and D105 each connecting between a DC power supply and a switch element are required to have a breakdown voltage that is three times as high as that of diodes D101 and D106, and also, diodes D103 and D104 are required to have a breakdown voltage that is two times as high as that of diodes D101 and D106. Accordingly, it is necessary for the multilevel inverter disclosed in PTD I to use diodes with different breakdown voltages or to connect two or three diodes in series for raising the breakdown voltage. Consequently, the device becomes complicated, and therefore, becomes difficult to be manufactured.

Furthermore, according to the multilevel inverter disclosed in PTD 1, when the number of levels of voltages to be output is further increased, each diode is required to have a further higher breakdown voltage. Consequently, the configuration of each diode connected between the DC power supply and the switch element becomes complicated, with the result that the device becomes more difficult to be manufactured.

Thus, the present invention has been made to solve the above-described problems. An object of the present invention is to provide a power conversion device having a configuration that can be readily manufactured.

### Solution to Problem

In order to solve the above-described problems, the present invention provides a power conversion device including: a group of serial three-level inverters including 2ⁿ three-level inverters connected in series, n being an integer equal to or greater than 1; and at least one switch circuit that selects an output from either one of two of the three-level inverters in the group of serial three-level inverters. The three-level inverters each include: first to fourth switch elements connected in series; two diodes connected in series between a first node and a second node, the first node connecting between the first switch element and the second switch, and the second node connecting the third switch element and the forth switch element; a first charge storage element connected between a third node connecting the diodes and the first switch element; and a second storage element connected between the third node and the fourth switch element. The three-level inverter is configured to be able to output three levels of voltages by a combination of ON states and OFF states of the first switch element to the fourth switch element. The group of serial three-level inverters includes 2ⁿ three-level inverters connected in series by repeated connection of a fourth node between the fourth switch element and the second charge storage element in one of the three-level inverters to a fifth node between the first switch element and the first charge storage element in another of the three-level inverters adjacent to the one of the three-level inverters. Also, 2ⁿ⁻¹ switch circuits are connected to be able to select an output from either one of the two adjacent three-level inverters in the group of serial three-level inverters. When there are two or more switch circuits, the switch circuit in a following stage is connected to be able to select an output from either one of two switch circuits connected in a previous stage, thereby providing one output.

### Advantageous Effects of Invention

According to the power conversion device of the present invention, the group of serial three-level inverters including a plurality of three-level inverters connected in series, and at least one switch circuit selecting an output from one of the plurality of three-level inverters are provided, so that elements each required to have a breakdown voltage can be concentrated in the switch circuit irrespective of the number of levels of voltages to be output. Accordingly, it becomes possible to provide a configuration that can be readily manufactured.

### BRIEF DESCRIPTION OF DRAWINGS

FIG. 1 is a circuit diagram showing the circuit configuration of a power conversion device according to the first embodiment of the present invention.

FIG. 2 is a waveform diagram showing a waveform of levels of voltages output from the power conversion device shown in FIG. 1.

FIG. 3 is a circuit diagram showing another circuit configuration of the power conversion device according to the first embodiment of the present invention.

FIG. 4 is a waveform diagram showing a waveform of levels of voltages output from the power conversion device shown in FIG. 3.

FIG. 5 is a circuit diagram showing the circuit configuration of the conventional power conversion device disclosed in PTD 1.

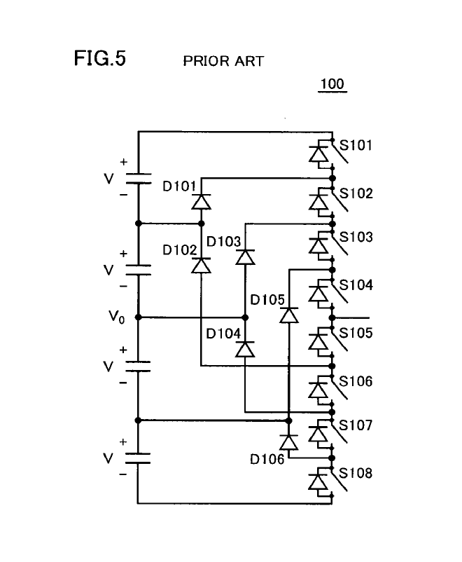

### DESCRIPTION OF EMBODIMENTS

Embodiments of the present invention will be hereinafter described in detail with reference to the accompanying drawings, in which the same or corresponding components are designated by the same reference characters.

### First Embodiment

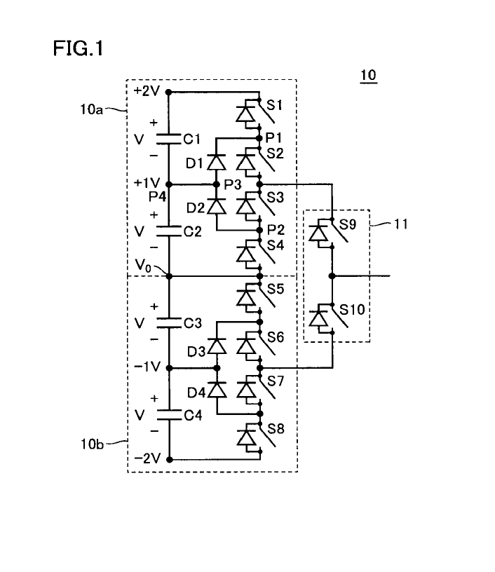

FIG. 1 is a circuit diagram showing the circuit configuration of a power conversion device according to the first embodiment of the present invention. A power conversion device 10 shown in FIG. 1 is a five-level inverter that can output five different levels of voltages. Power conversion device 10 includes four DC power supplies V, ten switch elements S1 to S10, four diodes D1 to D4, and an output terminal.

Power conversion device 10 includes: two three-level inverters 10a and 10b that each can output three different levels of voltages; and one switch circuit 11 that selects either one of two three-level inverters 10a and 10b. This three-level inverter 10a includes: four switch elements S1 to S4 connected in series; diodes D1 and D2 connected in series; and capacitors C1 and C2 connected in series and each serving as a DC power supply V. In three-level inverter 10a, diodes D1 and D2 are connected in series between a node P1 and a node P2. Node P1 connects between switch element S1 and switch element S2, and node P2 connects between switch element S3 and switch element S4. Furthermore, in three-level inverter 10a, capacitor C1 is connected between switch element S1 and a node P3 that connects between diodes D1 and D2, and capacitor C2 is connected between node P3 and switch element S4. Since three-level inverter 10b also has the same circuit configuration as that of three-level inverter 10a, detailed explanation thereof will not be repeated.

Switch circuit 11 is formed of switch element S9 and switch element S10. When switch element S9 or switch element S10 is turned ON, switch circuit 11 selects an output of three-level inverter 10a or three-level inverter 10b.

By turning switch elements S1 and S2 ON, three-level inverter 10a can output an electric potential “+2V” on the positive side of capacitor C1 in capacitors C1 and C2 connected in series. By turning switch elements S2 and S3 ON, three-level inverter 10a can output an electric potential “+1V” at node P4 between capacitors C1 and C2 connected in series. Furthermore, by turning switch elements S3 and S4 ON, three-level inverter 10a can output an electric potential “0V” on the negative side in capacitor C2 in capacitors C1 and C2 connected in series. Therefore, three-level inverter 10a can output three levels of voltages “1V”, “+1V”, and “+2V”.

Since three-level inverter 10b can perform the same operation as that of three-level inverter 10a, it can output three levels of voltages “0V”, “−1V”, and “−2V”.

Therefore, power conversion device 10 serves to switch the ON state of each of switch element S9 and switch element S10 in switch circuit 11, thereby selecting one of outputs of three-level inverters 10a and 10b connected in series, so that it can output five different levels of voltages (“−2V”, “−1V”, “0V”, “+1V”, and “+2V”) from the output terminal. It is to be noted that the electric potential on the negative side of capacitor C2 and the electric potential on the positive side of capacitor C3 are the same electric potential “0V”.

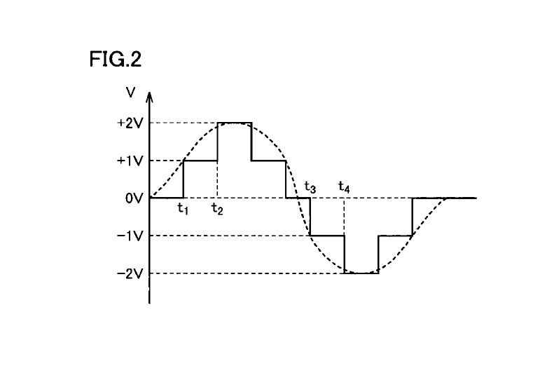

The operation of power conversion device 10 will then be described. FIG. 2 is a waveform diagram showing a waveform of the levels of voltages output from power conversion device 10 shown in FIG. 1.

First, power conversion device 10 turns switch elements S3 and S4 ON, and turns switch element S9 of switch circuit 11 ON (turns switch element S10 OFF), to output a voltage having a level of “0V” from the output terminal. Then, at time t1, power conversion device 10 turns switch elements S2 and S3 ON, and turns switch element S9 of switch circuit 11 ON, to output a voltage having a level of “+1V” from the output terminal.

Then, at time t2, power conversion device 10 turns switch elements S1 and S2 ON, and turns switch element S9 of switch circuit 11 ON, to output a voltage having a level of “+2V” from the output terminal. Then, power conversion device 10 lowers the voltage level from the output terminal to “+1” and “0” in this order.

In addition, power conversion device 10 may turn switch elements S5 and S6 ON, and turn switch element S10 of switch circuit 11 ON, to output a voltage having a level of “0V” from the output terminal.

At time t3, power conversion device 10 turns switch elements S6 and S7 ON, and turns switch element S10 of switch circuit 11 ON, to output a voltage having a level of “−1V” from the output terminal.

Then, at time t4, power conversion device 10 turns switch elements S7 and S8 ON, and turns switch element S10 of switch circuit 11 ON, to output a voltage having a level of “−2V” from the output terminal. Then, power conversion device 10 raises the voltage level from the output terminal to “−1” and “0” in this order.

Power conversion device 10 performs the operation of switching and outputting five different levels of voltages (“−2V”, “−1V”, “0V”, “+1V”, and “+2V”) as described above, so that it can output an AC voltage as indicated by a dashed line shown in FIG. 2 and also can convert DC power into AC power.

In switch elements S1 to S8 and diodes D1 to D4 forming three-level inverters 10a and 10b, only a voltage of one capacitor is applied to opposite ends of the elements when switch elements are OFF. In switch elements S9 and S10 forming switch circuit 11, when the output terminal outputs “+2V”, switch element S9 is turned ON and switch element S10 is turned OFF, so that a voltage corresponding to the sum of two capacitors is applied to opposite ends of switch element S10. Furthermore, in switch elements S9 and S10 forming switch circuit 11, when the output terminal outputs “−2V”, switch element S10 is turned ON and switch element S9 is turned OFF, so that a voltage corresponding to the sum of two capacitors is applied to opposite ends of switch element S9.

As described above, power conversion device 10 according to the first embodiment of the present invention is configured to include: the group of serial three-level inverters including two three-level inverters 10a and 10b connected in series and not requiring an element with a particularly high breakdown voltage; and switch circuit 11, so that an element receiving a high voltage can be limited only to an element constituting switch circuit 11. In other words, power conversion device 10 can be manufactured only by connecting two three-level inverters in series that are formed using elements each having an existing breakdown voltage, and providing a switch circuit that selects an output from one of the three-level inverters. Therefore, power conversion device 10 can be configured so as to be readily manufactured.

In addition, the power conversion device according to the first embodiment of the present invention is not limited to the power conversion device that can output five different levels of voltages, but can readily be increased in number of levels of voltages to be output by increasing the three-level inverters connected in series and the switch circuit.

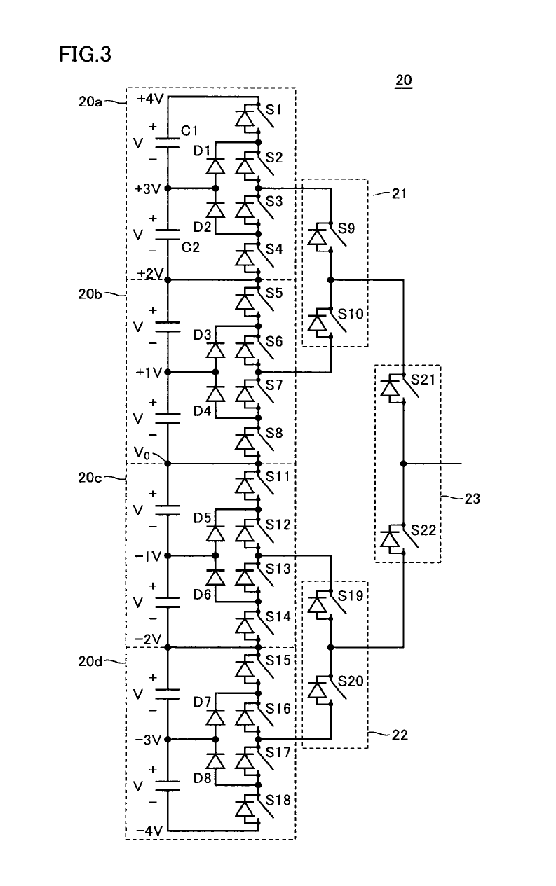

Specifically, FIG. 3 is a circuit diagram showing another circuit configuration of the power conversion device according to the first embodiment of the present invention. Power conversion device 20 shown in FIG. 3 is a nine-level inverter that can output nine different levels of voltages. Power conversion device 20 includes eight DC power supplies V, twenty-two switch elements S1 to S22, and eight diodes D1 to D8. In addition, a free wheel diode is connected to each of switch elements S1 to S22.

Power conversion device 20 includes: a group of serial three-level inverters in which four three-level inverters 20a, 20b, 20c, and 20d are connected in series; one switch circuit 21 that selects an output from either one of two three-level inverters 20a and 20b; one switch circuit 22 that selects an output from either one of two three-level inverters 20c and 20d; and a switch circuit 23 on the subsequent stage so as to allow selection of one of the outputs from two switch circuits 21 and 22 connected to the preceding stage.

The intermediate point of eight DC power supplies V is defined as a midpoint V0 and the voltage level at midpoint V0 is defined as “0V”. Accordingly, the voltage levels at the nodes of four DC power supplies V above midpoint V0 are “+1V”, “+2V” and “+3V” in this order starting from midpoint V0. Also, the voltage levels at the nodes of four DC power supplies V below midpoint V0 are “−1V”, “−2V”, and “−3V” in this order starting from midpoint V0. Furthermore, the voltage level at the node between DC power supply V and switch element S1 is “+4V” while the voltage level at the node between DC power supply V and switch element S18 is “−4V”.

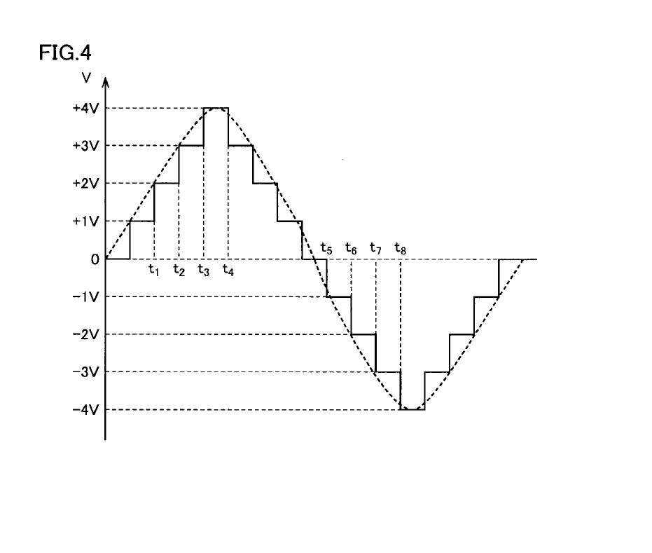

The operation of power conversion device 20 will then be described. FIG. 4 is a waveform diagram showing a waveform of levels of voltages output from power conversion device 20 shown in FIG. 3.

First, power conversion device 20 turns switch elements S7 and S8 ON, turns switch element S10 of switch circuit 21 ON, and turns switch element S21 of switch circuit 23 ON, to output a voltage having a level of “0V” from the output terminal. Then, at time t1, power conversion device 20 turns switch elements S6 and S7 ON, turns switch element S10 of switch circuit 21 ON, and turns switch element S21 of switch circuit 23 ON, to output a voltage having a level of “+1V” from the output terminal.

Then, at time t2, power conversion device 20 turns switch elements S5 and S6 ON, turns switch element S10 of switch circuit 21 ON, and turns switch element S21 of switch circuit 23 ON, to output a voltage having a level of “+2V” from the output terminal.

In addition, power conversion device 20 may turn switch elements S3 and S4 ON, turn switch element S9 of switch circuit 21 ON, and turn switch element S21 of switch circuit 23 ON, to output a voltage having a level of “+2V” from the output terminal.

Then, at time t3, power conversion device 20 turns switch elements S2 and S3 ON, turns switch element S9 of switch circuit 21 ON, and turns switch element S21 of switch circuit 23 ON, to output a voltage having a level of “+3V” from the output terminal.

Then, at time t4, power conversion device 20 turns switch elements S1 and S2 ON, turns switch element S9 of switch circuit 21 ON, and turns switch element S21 of switch circuit 23 ON, to output a voltage having a level of “+4V” from the output terminal. Then, power conversion device 20 lowers the voltage level from the output terminal to “+3V”, “+2V”, “+1V”, and “0V” in this order.

In addition, power conversion device 20 may turn switch elements S11 and S12 ON, turn switch element S19 of switch circuit 22 ON, and turn switch element S22 of switch circuit 23 ON, to output a voltage having a level of “0V” from the output terminal.

At time t5, power conversion device 20 turns switch elements S12 and S13 ON, turns switch element S19 of switch circuit 22 ON, and turns switch element S22 of switch circuit 23 ON, to output a voltage having a level of “−1V” from the output terminal.

Then, at time t6, power conversion device 20 turns switch elements S13 and S14 ON, turns switch element S19 of switch circuit 22 ON, and turns switch element S22 of switch circuit 23 ON, to output a voltage having a level of “−2V” from the output terminal.

In addition, power conversion device 20 may turn switch elements S15 and S16 ON, turn switch element S20 of switch circuit 22 ON, and turn switch element S22 of switch circuit 23 ON, to output a voltage having a level of “−2V” from the output terminal.

Then, at time t7, power conversion device 20 turns switch elements S16 and S17 ON, turns switch element S20 of switch circuit 22 ON, and turns switch element S22 of switch circuit 23 ON, to output a voltage having a level of “−3V” from the output terminal.

Then, at time t8, power conversion device 20 turns switch elements S17 and S18 ON, turns switch element S20 of switch circuit 22 ON, and turns switch element S22 of switch circuit 23 ON, to output a voltage having a level of “−4V” from the output terminal. Then, power conversion device 20 raises the voltage level from the output terminal to “−3V”, “−2V”, “−1V”, and “0V” in this order.

By performing the operation of switching and outputting nine different levels of voltages (“−4V”, “−3V”, “−2V”, “−1V”, “0V”, “+1V”, “+2V”, “+3V”, and “+4V”) as described above, power conversion device 20 can output an AC voltage as indicated by a dashed line shown in FIG. 4 and also can convert DC power into AC power.

As described above, in the power conversion device according to the first embodiment of the present invention, level inverters connected in series and a switch circuit are increased, thereby increasing the number of levels of voltages to be output, which can be represented by generalization as set forth below.

Specifically, the power conversion device according to the first embodiment of the present invention includes: the group of serial three-level inverters including 2ⁿ three-level inverters connected in series; and at least one switch circuit that selects an output from either one of two three-level inverters in the group of serial three-level inverters. Then, 2ⁿ⁻¹ switch circuits are connected such that an output from either one of two adjacent three-level inverters in the group of serial three-level inverters can be selected. In the case where two or more switch circuits are connected, the switch circuit in the following stage is sequentially connected such that an output from either one of two switch circuits connected in the previous stage can be selected, so that the power conversion device provides one output.

In addition, the power conversion device according to the embodiment of the present invention has been described while limiting the number of times of selecting the voltage level during a single AC cycle for the purpose of simplifying the explanation of the switch operation. However, switching is performed several times during a single AC cycle to select a voltage level several times, so that an AC voltage can be more meticulously output. Consequently, a power conversion device with further reduced harmonics can be implemented.

Furthermore, although a capacitor is used as a charge storage element in the power conversion device according to the embodiment of the present invention, the charge storage element is not limited thereto, but a DC power supply may be connected, for example.

Furthermore, although a charge storage element and a switch element or a diode are directly connected in the power conversion device according to the embodiment of the present invention, the present invention is not limited thereto, but may have a configuration in which a snubber circuit or the like is provided for suppressing a sudden change of the current, for example, in the transient state where the switch element is being turned on or off.

It should be understood that the embodiments disclosed herein are illustrative and non-restrictive in every respect. The scope of the present invention is defined by the terms of the claims, rather than the description above, and is intended to include any modifications within the meaning and scope equivalent to the terms of the claims.

### REFERENCE SIGNS LIST

10, 20 power conversion device, 10a, 10b, 20a to 20d level inverter, 11, 21 to 23 switch circuit, C1, C2, C3, C4 capacitor, D1 to D8 diode.

1. A power conversion device comprising:
a group of serial three-level inverters including 2ⁿ three-level inverters connected in series, n being an integer equal to or greater than 1; and
at least one switch circuit that selects an output from either one of two of said three-level inverters in said group of serial three-level inverters,
said three-level inverters each including
first to fourth switch elements connected in series,
two diodes connected in series between a first node and a second node, said first node connecting between said first switch element and said second switch, and said second node connecting said third switch element and said forth switch element,
a first charge storage element connected between a third node connecting said diodes and said first switch element, and
a second storage element connected between said third node and said fourth switch element,
said three-level inverter being configured to be able to output three levels of voltages by a combination of ON states and OFF states of said first switch element to said fourth switch element,
said group of serial three-level inverters including 2ⁿ said three-level inverters connected in series by repeated connection of a fourth node between said fourth switch element and said second charge storage element in one of said three-level inverters to a fifth node between said first switch element and said first charge storage element in another of said three-level inverters adjacent to said one of said three-level inverters,
2ⁿ⁻¹ said switch circuits being connected to be able to select an output from either one of two adjacent said three-level inverters in said group of serial three-level inverters,
when there are two or more said switch circuits, said switch circuit in a following stage being connected to be able to select an output from either one of two said switch circuits connected in a previous stage, thereby providing one output.

2. The power conversion device according to claim 1, further comprising a snubber circuit for suppressing a sudden change of a current between said switch element and said first charge storage element or said second charge storage element, and between said diode and said first charge storage element or said second charge storage element.
